(19) United States
(12) Patent Application Publication
(10) Pub. No.: US 2005/0147725 A1
(43) Pub. Date: Jul. 7, 2005

(54) Nutritional and energy reduced fiber-based baking ingredient having low glycemic index

(76) Inventor: Van Miller, Norval (CA)

Correspondence Address: Mr. Van Miller, P. O. Box 100, Norval, ON, L0P 1A0, CA

(21) Appl. No.: 10/751,535

(22) Filed: Jan. 6, 2004

(51) Int. Cl. A21D 10/00

(52) U.S. Cl. 426/549

(57) ABSTRACT

A nutritional and energy reduced fiber-based baking ingredient having a reduced glycemic index is intended for use in the baking industry, and comprises from 20% to 30% crude protein, from 50% to 80% fiber, up to 15% crude fat, and up to 2% of additional nutritional components chosen from the group consisting of lysine, amino acids, nutritional minerals, and mixtures and combinations. The reduced glycemic index fiber-based baking ingredient is derived from cereal grains chosen from the group consisting of wheat, barley, rye, corn, rice, oats, flax, and mixtures and combinations; and is initially derived as a by-product from the brewing or distilling industries. Breads, cookies, muffins, waffles, and nutribars, may be baked using the baking ingredient.

### FIELD OF THE INVENTION

This invention relates to baking ingredients, and particularly the present invention relates to cereal grain derived baking ingredients which have nutritional value, but which have reduced carbohydrate content relative to ordinarily used cereal-based baking ingredients. The energy reduced fiber-based baking ingredients of the present invention thus provide low glycemic index baking ingredients which easily find particular use in those segments of the baking industry that are devoted to the production of bread—particularly those breads other than white bread—as well as such baked products as cookies, muffins, waffles, and nutribars.

### BACKGROUND OF THE INVENTION

Currently, there is a trend in nutrition to reduce carbohydrate intake so as to assist in the attempts to overcome or preclude obesity. Particularly, if carbohydrate intake is reduced, then the lipids, which are part of the diet, in any event will assist the metabolism in converting foods into necessary energy. This helps the body to balance the intake necessary for all of its functions.

Glycemic Index is a ranking of carbohydrates based on their immediate effect on blood glucose (blood sugar) levels. Carbohydrates that break down quickly during digestion have the highest glycemic indices; the blood glucose response is fast and high. Carbohydrates that break down more slowly, and thus release glucose gradually into the blood stream, have low glycemic indices.

A low glycemic index for consumed foods thus means a smaller rise of blood glucose after meals, it can help people lose weight, and it can improve their sensitivity to insulin.

Put in other words, glycemic index is a measuring or rating mechanism to determine how quickly the body will metabolise carbohydrates and convert them to sugars. Obviously, if the energy provided by those sugars is not expended, then the unused energy eventually becomes stored energy as fat, leading in time to overweight conditions—and in extreme case, obesity.

Moreover, in the case of persons who are diabetic, they have an inability to produce insulin in the requisite quantities required for metabolism of blood sugars, or to secrete sufficient insulin to effectively adjust their blood glucose level. If the blood glucose level remains high in such individuals, it may in time lead to insulin shock or even death. Thus, the preferred method for controlling diabetes is insulin rejection.

However, in some cases, it may be sufficient to carefully monitor the glycemic index levels of ingested foods so as to control blood glucose levels. It is recognized, of course, that fructose is a unique sugar that does not require insulin for its metabolization, and thus it is used in the preparation of many diabetic foods.

However, the ordinary populace continues the trend to being overweight, and such problems as juvenile obesity are becoming severe public health concerns. Thus, there is a concerted effort on the part of public health authorities, and private entrepreneurs, to promote and provide plans and schemes to the public by which the level of carbohydrate ingestion may be reduced.

One widely promoted plan that is intended to reduce carbohydrate intake is the so-called Atkins Plan. This requires, however, that a participant in the plan shall purchase a considerable portion of their daily food intake from the purveyors of the plan.

It has quite unexpectedly occurred to the present inventor that the principal object of reduced carbohydrate diet plans is to reduce the carbohydrate intake by ingesting foods having lower glycemic indices, while maintaining reasonable caloric intake, and also maintaining reasonable volume intake of nutritious food. Since the preponderance of carbohydrate intake comes from consumption of baked goods such as breads, cookies, and the like, then there is a source of nutritional and energy reduced fiber-based products having low glycemic indices that can be employed in the baking industry to provide nutritional baked food products which have reduced carbohydrate content, and which therefore have reduced glycemic indices.

Indeed, there are two quite unexpected but related sources for nutritional and energy reduced fiber-based products having low glycemic indices. They are the brewing industry and the distilling industry, particularly those parts of those industries from whence beer and whiskey are derived. Specifically, the brewing and distilling industries have an important by-product which can be utilized in keeping with present invention, and that by-product is the spent grain that remains after the fermentation process by which the alcohol is derived from the grains has been concluded. The farming industry has recognized that wet brewers grain or spent grain derived from the brewing or distilling industries can be adapted to be a part of the feed which is provided to horses or cattle, particularly dairy cattle. It has been known that non-traditional feed sources such as spent grains can provide an economic source of protein and fiber which can supplement, but not replace, managed dietary programs for cattle and horses, such as those that are bred and raised on commercial ranches and farms.

It may also happen that when supply exceeds demand, the farming industry will utilize spent grains as soil fertilizer.

Such spent grains as may be derived from the brewing and distilling industries, however, are unknown for use in the human diet. Thus, it quite unexpectedly occurred to the present inventor that after the fermentation process has been completed, a very substantial portion of the energy—calories derived from the carbohydrates which are removed from the grains during the fermentation process—has been taken from the grain; and what remains therefore is grain from which the energy has been removed, but which still retains protein, fiber, fat content, and other nutritional components such as lysine, amino acids, and nutritional minerals. Moreover, such spent grains have low glycemic indices.

These conditions would seem to apply to most cereal grains, including without restriction wheat, barley, rye, corn, rice, oats, and flax. Of course, is recognized that typically the cereal grain that is employed in the brewing industry is barley, whereas cereal grains such as wheat, rye, or corn, in particular, are used in the distilling industry. Rice is particularly employed in the production of sake; and flax, oats, or other cereal grains may be employed for particular purposes of flavor and color in some brewed or distilled beverages.

Typically, after the fermentation has taken place and the starch portion of the cereal has been employed, then the remaining wet brewers grain or distillers grain—sometimes referred to as “spent grain”—consists of perhaps 75% to 80% of water and 20% to 25% of dry matter. That dry matter, in turn, may comprise from 20% to 30% of crude protein, from 50% to 80% of fiber, up to 15% of crude fat, and up to 2% of additional nutritional components such as lysine, amino acids, and nutritional minerals.

The fiber content will comprise differing types of fiber, including crude fiber or dietary fiber which can be assimilated by the digestive system, as well as nondietary fiber which is not assimilated by the digestive system and which provides bulk during the peristaltic or digestive process.

Thus, it has been unexpectedly discovered by the present inventor that the carbohydrate-reduced spent grains which may be derived from the brewing or distilling industries, and which have low glycemic indices, lend themselves perfectly to different applications in the baking industry where it is desired to produce energy-reduced breads, cookies, muffins, waffles, or nutribars having low glycemic indices. Typically such baked products are based on flours and flavors other than those which would be expected to be found in white bread. That is to say, the nutritional and energy reduced fiber-based baking ingredients which are provided by the present invention will particularly find themselves used in breads such as whole grain bread, whole wheat bread or rye bread, whole barley bread, multigrain breads, and the like. They also find themselves used in many kinds of cookies, recognizing that cookies are generally sweetened with sugar and will have additional flavors as well added to them.

However, by substituting some of the flours used in normal bread baking with spent grains, it becomes apparent that the available protein in the spent grains can assist in binding water in the bread formulation, and also assist in providing roughage intake as well as a non-caloric bulking agent in bread dough.

As to nutribars, it should be noted that those products are typically unleavened and are provided as extruded products which find themselves being consumed as snacks, or as so-called “sports bars”. However, a principal constituent of nutribars remains to be flour, and the product is considered to be a baked product.

Thus, it will be seen that the nutritional and energy reduced fiber-based baking ingredients of the present invention may be used by the baking industry as it supplies yeast-raised baked products such as breads and the like unleavened breads, muffins, cookies, or waffles, which rely on sodium bicarbonate or baking soda as a raising agent, or other unleavened products such as nutribars, to the market.

Of course, it is also recognized that most spent grains are quite acidic and very moist, and it may be necessary to adjust the acidity level and/or to dry the spent grains so as to prepare them for differing purposes where they may be employed in the baking industry as nutritional and energy reduced fiber-based baking ingredients.

As will be discussed hereafter, the necessity to neutralize or to dehydrate the spent grains will depend entirely on their end use as a baking ingredient in a particular type of baked product. For example, cookie production would require a quite dry ingredient, recognizing of course that cookies and biscuits will typically have a fairly long shelf life as opposed to yeast raised breads which have a quite higher moisture content.

Moreover, it should be noted that cookie or biscuit formulas, or those for waffles or nutribars, may have a high amount of flour substituted by the nutritional and energy reduced fiber-based baking ingredients of the present invention, so as to obtain a significantly carbohydrate reduced product; where unlike commercially available products available today, the substitution comes not from artificial fillers but from natural sources. The cost benefits, as well, are obvious.

A typical formulation for wet brewers grains is noted below. Of course, it will be recognized that the formulation which is given is one which is a typical analysis derived on a dry matter basis, and which is particularly intended for use by dairy cattlemen, and the veterinary and agricultural college professors who study dairy cattle. That dry matter basis formulation is as follows:

| | |
|---|---|
| Dry matter | 22.00% |
| Crude protein | 26.00% |
| Ether extract | 6.50% |
| Crude fiber | 17.00% |
| Acid Determined fiber | 21.00% |
| Nautral Digestive Fiber | 42.00% |
| Calcium | 0.35% |
| Phosphorus | 0.60% |
| Ruminant Total Digestive Nutrients | 77.00% |
| Nitrogen energy for maintenance | 1.89% |
| Nitrogen energy for weight gain | 1.26% |
| Nitrogen energy for lactating cows | 1.63% |

### DESCRIPTION OF THE PRIOR ART

Prior art patents which describe various attempts to provide bread products and bread formulations having low calorie content, as well as a method of treating spent grain are noted below. It will be apparent that there has been an interest in the provision of high fiber baked goods for a number of years, and that both science and industry have utilized various techniques to add fibers from many sources such as pea fibers, brans, almond hulls, etc., to the formulations being prepared. Typically, this has involved separating, grinding, and blending the fibers and adding them to the dough system.

THOMPSON U.S. Pat. No. 4,109,018 teaches a bread product and a dough composition for making a bread product—which typically is white bread—where an alpha cellulose flour, a hydrophilic gum, additional wheat gluten, nonfat dry milk, and other ingredients are employed to provide protein and roughage content and lower calorie content when compared with standard whit bread

DREESE et al U.S. Pat. No. 4,377,601 teaches methods of removing hulls from spent brewers grain using a roller. Also, once the bran has been recovered by passing the milled mixture through a sieve, bread can be made with the bran by mixing it with oil and a surfactant before the other bread ingredients are added.

SCHMIDT U.S. Pat. No. 4,711,786 describes a high fiber bread or an extruded baked product which particularly includes pea flour and ground pea hulls.

HODGSON et al U.S. Pat. No. 4,824,683 teaches a composition which may be used to make a low calorie and high fiber content bread product where a pre-gelatinised pea bran, and a pre-gelatinised oat bran, and optionally soy flour, are employed.

### SUMMARY OF THE INVENTION

In accordance with one aspect of the present invention, there is provided a nutritional and energy reduced fiber-based baking ingredient having a reduced glycemic index, and which comprises 20% 30% crude protein, from 50% to 80% fiber, up to 15% of crude fat, and up to 2% of additional nutritional components which are chosen from the group consisting of lysine, amino acids, nutritional minerals, and mixtures and combinations thereof.

The reduced glycemic index fiber-based baking ingredient is derived from cereal grains chosen from the group consisting of wheat, barley, rye, corn, rice, oats, flax, and mixtures and combinations thereof.

It is an important aspect of the present invention that the reduced glycemic index fiber-based baking ingredient has been initially derived as a by-product from the brewing or distilling industries.

Typically, the reduced glycemic index fiber-based baking ingredient comprises from 50% 70% of a high fiber, high protein, low moisture baking additive with the balance being water.

However, the reduced glycemic index fiber-based baking ingredient of the present invention may comprise from 20% to 25% of a high fiber, high protein, high moisture baking additive, with the balance being water.

In general, at least initially, the reduced glycemic index fiber-based baking ingredient of the present invention has a pH level which is acidic, generally in the range of from 2.5 to 6.9.

However, the reduced glycemic index fiber-based baking ingredient of the present invention may have its pH level adjusted to be in the range of from 7.0 to 11.5, by the addition of an alkali which is ingestible by humans.

Typically, the alkali is sodium bicarbonate.

A feature of the present invention is that baked products incorporating the reduced glycemic index fiber-based baking ingredients described above may be provided.

For example, a yeast raised baked bread product may be provided which includes flour, yeast, and from 10% to 60% by weight thereof of the above-described high moisture reduced glycemic index fiber-based baking ingredient.

On the other hand, the above-described low moisture fiber-based baking ingredient may be employed in a baked cookie, muffin, or waffle product which includes flour, and non-yeast raising agent, and from 10% to 60% by weight thereof of the above-described low moisture reduced glycemic index fiber-based baking ingredient.

Moreover, the same low moisture fiber-based baking ingredient may also be employed in the formulation of a baked nutribar product which includes from 10% to 80% by weight thereof of the low moisture reduced glycemic index fiber-based baking ingredient.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

It has been previously stated that a specific purpose and objective of the present invention is to provide a baking ingredient which permits carbohydrate reduced baked products to be manufactured for human consumption, and which have low glycemic indices. It has been remarked that this goal is primarily obtained by the use of spent grains from the brewing or distilling industries, where most of the energy has already been removed from the grains by the fermentation process which uses the starch portion of the grains, leaving a product which is high in fiber and protein, having a low glycemic index, and which may comprise a reasonable level of crude fat, along with other nutritional components including nutritional minerals and the like.

Whether the spent grain that is employed in keeping with the present invention is wet or dry, relatively speaking, and whether it is acidic or has had its pH level adjusted to become either neutral or alkaline, depends particularly on the use to which the spent grain is to be put.

For example, the acid level may be kept high, and the moisture level dried to about 15%, which thereby creates a dry spent grain product which is very high in protein and fiber, and low in moisture.

Alternatively, the acid level may be reduced by neutralizing the spent grain product particularly by use of sodium bicarbonate or baking soda.

It will also be recognized that for bread and other yeast raised baked products, where water is added to the formulation, it may be more cost-effective to add less water to the dough system and to use the wet spent grain more or less as is. Of course, the acidity level may be adjusted to suit the specific purpose for which the fiber-based baking ingredient is to be employed.

If the fiber-based baking ingredient of the present invention comes from the brewing industry, then typically the cereal grain from which the spent grain has been derived is barley. Likewise, if the fiber-based baking ingredient of the present invention comes from the distilling industry, then typically the cereal grain from which the spent grain has been derived is usually wheat, rye, or corn. However, as noted, other cereal grains may also have been employed in the brewing or distilling industries, including rice, oats, and flax. Thus, the fiber-based baking ingredient of the present invention may be derived from any, or any combination, of the cereal grains noted above.

If the fiber-based baking ingredient of the present invention is to be employed as a low moisture baking additive, then typically it will comprise from 50% to 70% of fiber, and it will be high in protein while low in moisture.

If, the other hand, the fiber-based baking ingredient of the present invention is to be employed is a high moisture baking additive, then typically it will comprise from 20% to 25% of fiber, while it will be high in protein and high in moisture.

It has been noted above that typically the pH level of the fiber-based baking ingredient, at least initially, is acidic and may be in the range of from 2.5 up to 6.9. On the other hand, the pH level may be adjusted by the use of an alkali which is ingestible by humans, such as sodium bicarbonate, to a pH level which may be in the range of from 7.0 up to 11.5.

A few comments concerning the importance of low glycemic index foods now follow. First, it is recognized that the time of day when the food is consumed may have some bearing on how quickly the metabolization of that food will occur. Lipid content of the food, the blood insulin level of the person consuming the food, and the level of physical activity of that person, are also factors.

For purposes of the present discussion, it will be assumed that the glycemic index of ordinary commercially available baked white bread is 100. If a whole wheat bread is produced using spent grains in keeping with the present invention, then it may have a glycemic index as low as 30. A comparison of several typical foods having low high and low glycemic indices is given below, it being understood that the glycemic indices noted for breads and cookies made in keeping with the present invention are dependent in part on the particular formulation and ingredients being used. However, it will also be noted that the glycemic indices for such baked products are significantly lower than white bread, for example, and even ordinary commercially available breads, cookies, and milk.

Foods Glycemic Index Comparison

| High Glycemic Index Foods | | Low Glycemic Index Foods | |
|---|---|---|---|
| | Glycemic | | Glycemic |
| Food | Index | Food | Index |
| White Bread | 100 | Pumpernickel | 66 |
| Melba Toast | 100 | Oat Bran Bread | 72 |
| Rice Krispies ™ | 117 | Digestive Cookies | 84 |
| Corn Flakes | 119 | Milk | 40 |
| Instant Rice | 124 | Brewers Spent Grain Bread | 25-30 |
| Potato (boiled/ | 104 | Brewers Spent Grain Cookies | 30-40 |
| mashed) | | | |
| French Fries | 107 | | |

It will also be easier to understand the present invention, and its application to its use as a baking ingredient, with reference to the following examples.

First, an example is given of the use of a low moisture fiber-based baking ingredient having a low glycemic index, in a formulation for a typical oatmeal cookie. Such cookies are made from primarily dry ingredients, and in this case the fiber-based baking ingredient would comprise from 50% to 70% of fiber, while being low in moisture. The formulation for the typical oatmeal cookie, when baked using ordinary wheat flour and rolled oats, is as follows for the present example:

| Grams | Ingredient | Cal/gram | Calories |
|---|---|---|---|
| 750 | Wheat Flour | 3.25 | 2437.5 |
| 500 | Rolled Oats | 3.9 | 1950 |
| 750 | Sugar | 4 | 3000 |
| 600 | Butter | 7.50 | 4500 |
| 200 | Whole eggs | 1.5 | 300 |
| 15 | Baking Soda | 0 | 0 |
| 2815 | Totals | 4.33 | 12187.5 |
| Grams | Ingredient | Cal/gram | Calories |

It will be understood from the above that in the dough stage, there is a 4.33 calories per gram energy constituent, and carbohydrates contribute approximately 60% of that calorie constituent.

Now, assume that an energy reduced fiber-based baking ingredient in keeping with the present invention substitutes the first two constituents of the formulation. The following table shows the result of such substitution. It must be noted that the following table has been calculated on the basis of a substitution of wheat flour and rolled oats by wheat flour and dried spent grain as the energy reduced fiber-based baking ingredient. However, instead of a full substitution of 1000 g of dried spent grain, for purposes of flavor and so as to permit labeling that the product contains oats, the substitution could instead be 900 g of dried spent grain and 100 g of rolled oats. The values would be very slightly higher, but not significantly, than those shown in the following table.

| | | | | | | | |
|---|---|---|---|---|---|---|---|
| | | | | Fiber and | | | |
| | Total | Moisture | Protein | Fats | | Calories From | Total |
| Ingredient | Grams | (grams) | (grams) | (grams) | Carbohydrates | Carbohydrates | Calories |

Traditional Cereal Inclusion

| | | | | | | | |
|---|---|---|---|---|---|---|---|
| Wheat flour | 750 | 112 | 75 | 63 | 500 | 2053 | 2300 |
| Rolled Oats | 500 | 50 | 75 | 50 | 375 | 1300 | 1600 |

| | | |
|---|---|---|
| Total | 3353 | 3900 |

Using Carbohydrate Reduced Cereal

| | | | | | | | |
|---|---|---|---|---|---|---|---|
| Wheat flour | 250 | 38 | 25 | 120 | 175 | 700 | 800 |
| Dried spent grain | 1000 | 150 | 250 | 600 | 0 | 0 | 1000 |

| | | |
|---|---|---|
| Total | 700 | 1800 |
| Total Reduction in Carbohydrate Caloric Values | 2653 | 2100 |

It is seen from the above table that there is a very significant reduction in carbohydrate caloric values in the formulation which employs the energy reduced fiber-based baking ingredient, having a low glycemic index, in keeping with the present invention. It is seen that apart from the first two ingredients of the formulation noted above, the balance of the formula remains the same as far as the amount of sugar, butter, eggs, and leavening agent (baking soda) are concerned. The protein in the dried spent grain will act to bind the available moisture, and the texture of the oatmeal is either completely or nearly completely—depending on whether a small amount of rolled oats is employed, or not—replaced by the texture and the absorption capabilities of the dried spent grain.

The following table shows the calorie contribution from the protein, notwithstanding that the total caloric value is significantly reduced. Thus, the additional moisture binding properties of the substituted formulation will be clearly understood.

Calories From Protein

| | Protein | | |
|---|---|---|---|
| Formulae | (grams) | Calories/Gram | Total |
| Traditional Cereal Inclusion | 150 | 4 | 600 |
| Using Carbohydrate Reduced Cereal | 275 | 4 | 1100 |

A similar analysis now follows with respect to yeast raised baked goods, specifically bread. The precise formulation of the bread is immaterial, because the purpose of the following analysis is to show the effect of the substitution of the energy reduced fiber-based baking ingredient having a low glycemic index in keeping with the present invention, in a typical whole wheat bread formulation. The analysis is predicated on caloric contribution by each of the principal constituents of the whole wheat bread formulation, expressed in terms of calories per 100 grams.

First, there follows an analysis of an ordinary whole wheat bread formulation, indicating the caloric contribution by each of the principal ingredients or ingredient groupings of that formulation.

Baked Whole Wheat Bread

| | | | Calories | |
|---|---|---|---|---|
| | % Of | Grams Per | Per | Calories Per 100 |
| Composition | Total | 100 Grams | Gram | Grams |
| Moisture | 41% | 41 | 0 | 0 |
| Protein | 7% | 7 | 4 | 28 |
| Fat | 1% | 1 | 9 | 9 |
| Starches | 41% | 41 | 4 | 164 |
| Dietary Fibers | 8% | 8 | 0 | 0 |
| Minerals | 2% | 2 | 0 | 0 |
| Totals | 100 | 100 | | 201 |

It will be seen from the above that this formulation for whole wheat bread results in total caloric contributions by all of the ingredients in the amount of 201 calories per 100 grams.

There now follows a further analysis of a baked whole wheat bread in which an energy reduced fiber-based baking ingredient in keeping with the present invention has been employed. The caloric contribution by each of the principal ingredients or ingredient groupings of that formulation is as follows:

Baked Whole Wheat Bread With Carbohydrate Reduced Spent Grain

| | | | Calories | |
|---|---|---|---|---|
| | | Grams Per | Per | Calories Per 100 |
| Composition | | 100 Grams | gram | grams |
| Moisture | 41% | 41 | 0 | 0 |
| Protein | 13% | 13 | 4 | 52 |
| Fat | 1% | 1 | 9 | 9 |
| Starches | 10% | 10 | 4 | 40 |
| Dietary Fibers | 30% | 30 | 0 | 0 |
| Minerals | 3% | 3 | 0 | 0 |
| Totals | 100 | 100 | | 101 |

Here, it is seen that the total caloric contributions by all of the ingredients in the formulation has been reduced by about one-half—from 201 calories per 100 grams to 101 calories per 100 grams—of the baked whole wheat bread.

Once again, a comparison may be made between the two formulations; and the comparison also shows the considerably reduced caloric contribution from carbohydrates in the baked whole wheat bread formulations.

Calorie Per Gram Comparison

| | | From |
|---|---|---|
| Formulae | Total | Carbohydrates |
| Baked Whole Wheat Bread | 2.01 cal/g | 1.64 cal/g |
| Baked Whole Wheat Bread With | 1.05 cal/g | .40 cal/g |
| Carbohydrate Reduced Spent | | |
| Grain | | |
| Reduction | 0.96 cal/g | 1.24 cal/g |

It should be noted that particularly when bread is being baked using the energy reduced fiber-based baking ingredients having low glycemic indices, in keeping with the present invention, it may be necessary to adjust the gluten content for the bread. This may, in part, depend on the source of the spent grain. For example, spent grain that has been derived from wheat may have a relatively high gluten content in the form of glutamic acid. On the other hand, fiber-based baking ingredients that may have been derived from, for example, barley or rye, would require gluten adjustment.

Thus, it is recognized that, particularly when making bread, the inclusion of fibers is sensitive as to the water carrying capacity and the water binding capacity of the proteins in the spent grains which differ among different grains. The water carrying and binding capacities of barley, for example, will differ than those of wheat.

Of course, it is known that wheat is used in beer making in various parts of the world and for specific types of beer. The resulting protein in the spent grains from those breweries may contain sufficient gluten so that the water binding capacity and the lift or “oven spring” of the baked bread will be identical to those of regular baked wheat bread. However, the texture of the spent grains bread is courser because of the lack of starches in the dough system.

On the other hand, if the spent grains come from barley, as is usually used in the brewing industry, than there may be the necessity to add vital gluten to the dough system so as to achieve the desired oven spring of the baked bread.

Thus, when yeast doughs are made in keeping with the present invention, the spent grain flour may be processed to have a specific particle size, and in some whole grain breads a substitution of up to 80% of the flour constituent may be made. If the oven spring is not sufficient, then up to 6% or 8% vital gluten may be added to the dough system. The end result is a carbohydrate protein fortified bread or bun with increased fiber content.

For muffins and cakes, that is non-yeast raised baked goods, no gluten addition is necessary. The spent grain flour acts as ordinary flour in the cake and muffin dough systems, and may replace as much as 80% of standard flour in such systems. In those dough systems, the fiber and protein act as a water binder, and the formula can be adjusted to an exact moisture content so as to keep both nutritional and quality claims for the baked goods.

As to cookies and nutribars, it is imperative that the moisture content be driven to a low level—typically, as low as 8% or 10%. At this low moisture level, spent grain can replace almost all other cereal grains such as wheat, oats, or rice, in the interest of carbohydrate reduction.

The fat content of the nutritional, energy reduced fiber-based baking ingredients in keeping with the present invention may vary, and may be as high as 15%. Typical fat contents of spent grains derived from distillers may have fat contents of 5% to 12%, for example, while the fat contents of spent grains derived from breweries may be slightly lower in the overall range.

Of course, it will also be understood that the nutritional, energy reduced fiber-based baking ingredients of the present invention will also include additional nutritional components such as lysine, amino acids, and nutritional minerals such as calcium and phosphorus, in particular.

There has been described a nutritional and energy reduced fiber-based baking ingredient having low glycemic indices, for use in the baking industry, whose use particularly lends itself to persons seeking to undertake a carbohydrate reduced diet regime. Several examples have been shown as to how use of the energy reduced fiber-based baking ingredients results in lower carbohydrate constituents and lower caloric values of typical baked products such as cookies and bread.

Spent grain, particularly wet spent grain, may have an appearance of granular mud, and typically wet spent grain has a rather unattractive odor which comes particularly as a consequence of ethanol which may remain as part of the moisture of the spent grain. However, any ethanol which is present will escape or be driven off when the spent grain is either dried or baked, so there will be no flavor or odor contribution by the ethanol to any baked product prepared in keeping with the present invention.

Other modifications and alterations will be apparent to those skilled in the baking industry, and to those whose purpose is to provide baking ingredients to the baking industry, without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

1. For use in the baking industry, a nutritional and energy reduced fiber-based baking ingredient having a reduced glycemic index, comprising from 20% to 30% crude protein, from 50% to 80% fiber, up to 15% crude fat, and up to 2% of additional nutritional components chosen from the group consisting of lysine, amino acids, nutritional minerals, and mixtures and combinations thereof:
wherein said fiber-based baking ingredient is derived from cereal grains chosen from the group consisting of wheat, barley, rye, corn, rice, oats, flax, and mixtures and combinations thereof; and
wherein said fiber-based baking ingredient is initially derived as a by-product from the brewing or distilling industries.

2. The reduced glycemic index fiber-based baking ingredient of claim 1, wherein said fiber-based baking ingredient comprises from 50% to 70% of a high fiber, high protein, low moisture baking additive, with the balance thereof being water.

3. The reduced glycemic index fiber-based baking ingredient of claim 1, wherein said fiber-based baking ingredient comprises from 20% to 25% of a high fiber, high protein, high moisture baking additive, with the balance thereof being water.

4. The reduced glycemic index fiber-based baking ingredient of claim 1, wherein, the pH level is acidic, in the range of from 2.5 to 6.9.

5. The reduced glycemic index fiber-based baking ingredient of claim 1, wherein the pH level has been adjusted to be in the range of 7.0 to 11.5, by the addition of an alkali which is ingestible by humans.

6. The reduced glycemic index fiber-based baking ingredient of claim 5, wherein the alkali is sodium bicarbonate.

7. A yeast raised baked bread product which includes flour, yeast, and 10% to 60% by weight thereof of the reduced glycemic index fiber-based baking ingredient of claim 3.

8. A baked cookie, muffin, or waffle product which includes flour, a non-yeast raising agent, and 10% to 60% by weight thereof of the reduced glycemic index fiber-based baking ingredient of claim 2

9. A baked nutribar product which includes 10% to 80% by weight thereof of the reduced glycemic index fiber-based baking ingredient of claim 2.
